(19) United States
(12) Patent Application Publication
(10) Pub. No.: US 2014/0195413 A1
(43) Pub. Date: Jul. 10, 2014

(54) Unique and revolutionary way of financing

(71) Applicant: David John DeJesus, Land O Lakes, FL (US)

(72) Inventor: David John DeJesus, Land O Lakes, FL (US)

(21) Appl. No.: 13/735,363

(22) Filed: Jan. 7, 2013

(51) Int. Cl. G06Q 40/02

(52) U.S. Cl. CPC G06Q 40/025
USPC 705/38

(57) ABSTRACT

The problem is the loss of economic value of manufactured products over time due to economic forces, wear and tear such as automobiles, electronic devices, structures and other manufactured or assembled products, but it is not taken as a factor in the terms of the loan of which such products were purchased by the consumers. My method called “Cascading Financing” takes into consideration the loss of value of such goods and products and incorporates it in the terms of the loan through the reduction of interest rate every term/year/month the loan is satisfied. Over time “Cascading Financing” will be used in financial transactions to reward the consumer/debtor for the timely payment or satisfaction and of the customer loyalty. It can be spun into other creative forms of financing as long as the basic core of “Cascading Financing” is applied, i.e. reduction of interest rate over the terms agreed upon by parties involved.

The present invention relates The Cascading Method of financing.

The core of the invention/idea is when a loan is made for a manufactured product such as cars, automobiles, electronic devices, the “Cascading Financing” takes the loss of value of such products and incorporates it by reducing the interest rate of the loan every certain term such as a year or month, that the loan is satisfied. Such novel way of financing can be used to other financial transactions such as all kinds of loans, credit cards and other forms of credit.

The important element is that there is a loan and that loan has terms to satisfy. It can be used to any type of loan for that matter.

The “Cascading Financing” will apply not only on manufactured products but also to other financial transactions such as loans, credit cards and other forms of credit.

The process works by reducing the interest rate of the loan every term/year/month that the loan is satisfied until it bottoms out in the last term of the loan.

Any financial computers or software's performing financial functions. It could also be used manually.

It can be used where there is a financial transaction requiring credit.

The invention can be used in any financial transaction requiring credit.

There has never been anything such as my method used in the financial world history.

There is no current financial system nor institution that uses this term of financing. It will be the first to be introduced in financial transactions.

What is claimed is:

1. The Cascading Method of Financing.
